(19) United States
(12) Patent Application Publication
(10) Pub. No.: US 2007/0168697 A1
(43) Pub. Date: Jul. 19, 2007

(54) Distributed data server and an operating method thereof

(76) Inventors: Yeh-Liang Hsu, Jhongli City (TW); Chang-Huei Wu, Jhongli City (TW); Chih-Ming Cheng, Jhongli City (TW); Hong-Xiang Ma, Jhongli City (TW); Jun-Lin Lin, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/600,025

(22) Filed: Nov. 16, 2006

(30) Foreign Application Priority Data
Dec. 27, 2005 (TW) 94146820

(51) Int. Cl. G06F 17/30; G06F 11/00

(52) U.S. Cl. 714/4

(57) ABSTRACT

A distributed data server is a portable data server that is built by incorporating it with an embedded system. The distributed data server can receive outside data through an input unit, process the outside data via a control unit and then store the processed data to a storage unit. The server provides a network unit for the outside world to inquire about the processed data via the Internet. The server further offers a display unit to show a data message that is outputted from the control unit. In addition, the control unit can determine whether a plurality of states of data being written onto the storage unit are abnormal and, if so, output an abnormal signal as a warning. Hence, the distributed data server can reduce the huge systematic structure of the known distributed data server and construct any type of monitoring system flexibly.

### BACKGROUND OF THE INVENTION

1. Field of the Invention

The present invention is generally related to a server and an operating method thereof, and more particularly, a portable data processing server and an operating method thereof.

2. Description of Related Art

Presently, most off-site data servers transfer data to a centralized database over the Internet for further storage and management. In this way, it acts as a base for relevant applications for clients. But the scale of such system structure is too large and the cores of such systems are all constructed in a possessive institutional unit or Information Service Provider (ISP). Therefore, more investment is required for base construction and the usages and applications are less flexible.

Over recent years, a lot of applications on off-site data servers have adapted a kind of broadcast synchronization coordination mechanism to construct a monitoring system for receiving and collecting information in many specific zones for the long term. For this construction, there are many devices that are required in each zone, including at least one computer host and a relative monitoring device for collecting and transferring data to a special purpose server host. The special purpose server host integrates, analyzes and evaluates the collected data for eventually answering inquiries.

Relative to such enormous systems, there must be some points that are needed to be considered carefully, such as equipment, costs and flexible operations for construction. Therefore, there needs to be an improvement towards simplification, greater flexibility and customized application development.

### SUMMARY OF THE INVENTION

In view of this, one object of the present invention provides a distributed data server that is built by incorporating it with an embedded system. The distributed data server is provided as a portable server host for conveniently being configured in each zone. Furthermore, the server of the present invention may simply change each monitoring environment in original client locations to be a server type via a network environment in each zone for directly managing data for analysis, evaluation, storage and transfer. Moreover, the server of the present invention provides users an independent server host system for inquiring after relative data, meanwhile it also let users feel that their use is occurring in a single system instead of multiple hosts linked together over the Internet.

A distributed data server of the present invention includes a control unit, a time control unit for providing time information required by the control unit, an input unit that is a data input interface which is coupled to the control unlit, at least one storage unit for recording data which is processed, calculated or analyzed by the control unit and is for answering remote queries, a display unit for displaying information provided by the control unit, a power supply unit for providing power to the control unit, the time control unit, the display unit and the storage unit when they are operating, and a network unit configured to be coupled to the control unit that is a communication interface for the Internet, whereby the control unit may determine an abnormal situation of data recorded by the storage unit and further outputting an abnormal signal to show that abnormal situation.

The general description above and the following details as well as the drawings are all used to further illustrate those manners, means, and efficacies employed in the present invention to achieve the desired purposes. Other purposes and advantages of the present invention will be explained also in the following descriptions and drawings.

### BRIEF DESCRIPTION OF THE DRAWINGS

FIG. 1 is a block diagram according to an embodiment of the present invention

FIG. 2 is a flowchart according to an embodiment of the present invention; and

FIG. 3 is another flowchart according to an embodiment of the present invention.

### DETAILED DESCRIPTION OF THE PREFERRED EMBODIMENTS

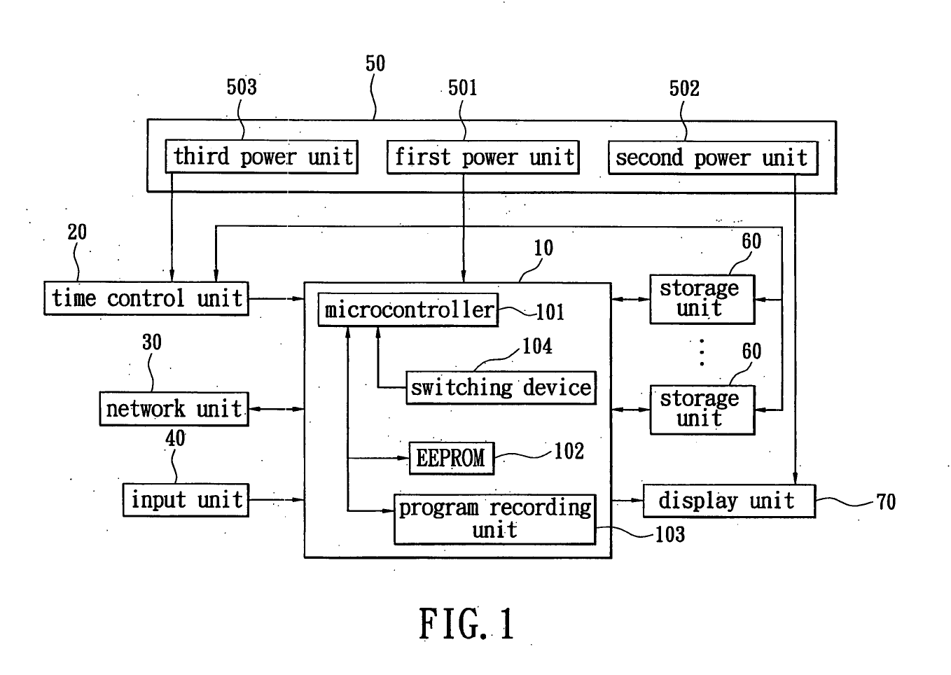

FIG. 1 is a block diagram according to an embodiment of the present invention. As shown in FIG. 1, the present invention provides a portable distributed data server. The server of the invention comprises a control unit 10, a time control unit 20, a network unit 30, an input unit 40, a power supply unit 50, at least one storage unit 60, and a display unit 70.

The control unit 10 includes a microcontroller 101, an electrically erasable and programmable ROM (EEPROM) 102, a program recording unit 103 and a switching device 104. The recording unit 103 may record a firmware program with a function of a network server to the EEPROM 102, wherein besides storing the firmware program, the EEPROM 102 may provide a monitoring mode and a time adjusting mode, reporting said modes for further executing, and incorporating with the microcontroller for operating. The microcontroller 101 which belongs to a single chip controller may be arranged with the recording unit 103 to make the controller 10 an embedded system. Additionally, modes of the distributed data server may be selected by the switching device 104 via a switching manner.

A time control unit 20 is configured to provide time information required by the control unit 10 in operation. The input unit 40 is configured to receive and collect information outside data, wherein the outside data may be processed, calculated and analyzed by the control unit 10 and then written to the storage unit 60 for inquiring and accessing by the network unit 30 external of the Internet. The storage unit 60 may be a MultiMedia Card/RSMMC/MM, a SecureDigital Card/MiniSD/MicroSD, a Memory Stick/Memory Stick PRO/Memory Stick Duo/Memory Stick PRO Duo, a Type I/II Compact Flash Card, a MicroDrive, a SmartMedia Card/xD, a NAND Flash Memory or a Hard Disk Drive, etc. The network unit 30 may be a wired or wireless network card. Additionally, the control unit 10 may determine whether an abnormal situation of data recorded by the storage unit 60 and the network unit 30 may further output an abnormal signal to show that abnormal situation, wherein the abnormal signal may be an I/O signal and have another way of showing up, such as by being written to the storage unit 60 and shown on the display unit 70. The display unit 70 may be a kind of a Super Twisted Nematic (STN), a Color Super Twisted Nematic (CSTN), a Thin Film Transistor (TFT), a Thin Film Diode (TFD) or an Organic Light Emitting Diode (OLED), etc.

The power supply unit 50 includes a first power unit 501 for providing the power required by the control unit 10, the time control unit 20 and the storage unit 60 when they are operating. A second power unit 502 included by the power supply unit 50 is an independent power source for the display unit 70 so as to avoid a problem of there being insufficient power occurring due to sharing power with the control unit 10. A third power unit 503 also included by the power supply unit 50 is a back-up power for ensuring the time control unit 20 may operate normally after being shut down by the first power unit 501, wherein the third power unit 503 may be a kind of carbon battery, an alkaline battery, a Li battery, a pen battery, a Nickel-Cadmium battery, a Nickel-Metal Hydride battery, or a Li-ion battery, etc.

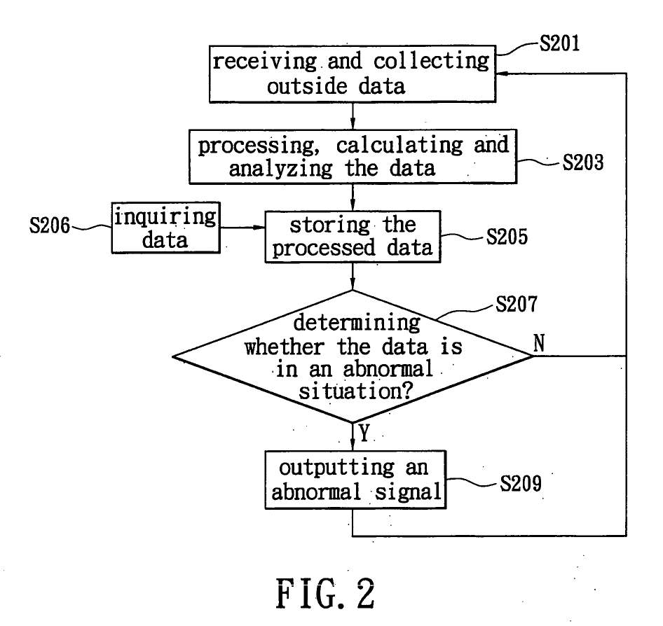

Please refer to FIG. 1 and FIG. 2, wherein FIG. 2 is a flowchart according to a first embodiment of the present invention. In S201, outside data is received and collected by the input unit 40 via a wired or wireless method, then in S203, the data is processed, calculated and analyzed by the control unit 10. In step 205, the processed data is stored in available addresses of the storage unit 60, wherein the available addresses correspond to time information provided by the time control unit 20. It deserves to be mentioned that if external users want to inquire after relative data in the storage unit 60 (in S206), they may use the Internet to inquire through the network unit 30. After finishing storing the data, the control unit 10 may determine whether the data is in an abnormal situation (in S207). If a determining result is true in S207, an abnormal signal is outputted in S209. On the contrary, the present invention may repeat data receiving and collecting in S201 whether the determining result is false in S207 or after S209. The abnormal situations mentioned above may be a situation of an environmental temperature being higher than a predetermined temperature or a situation where no changeable activation has occurred in the monitoring data for a long time. When determining that those values are identified with abnormal situations, which are set by the control unit 10, then S209 is performed to output an abnormal signal for warning, wherein the abnormal signal may be an I/O signal for triggering a warning device and the information issuing device.

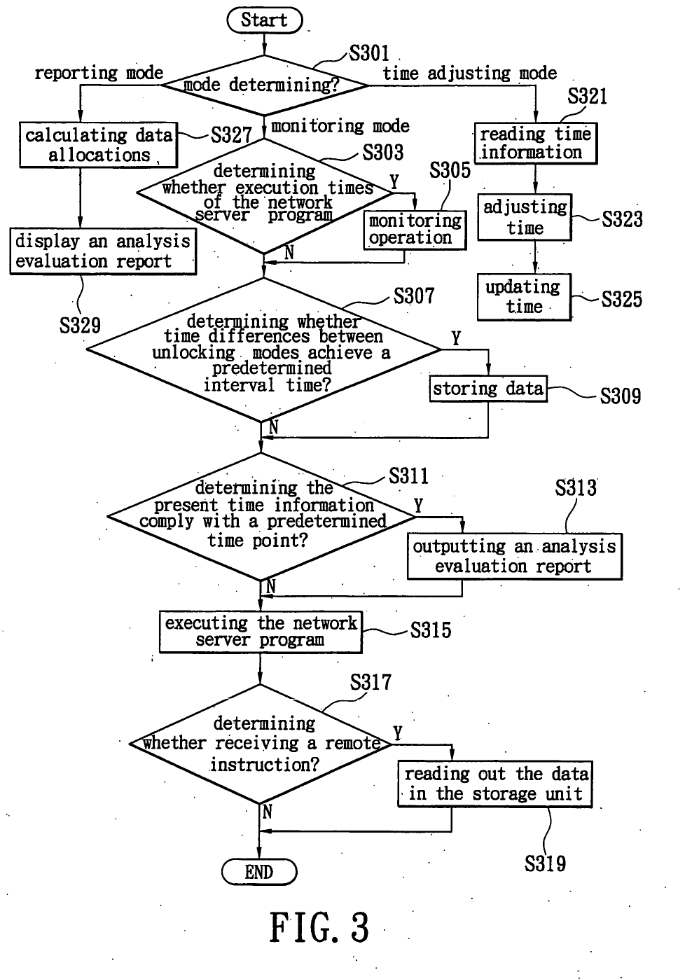

Please refer to FIG. 1 and FIG. 3, wherein FIG. 3 is a flowchart of another embodiment of the present invention. In S301, a present mode which exists in the distributed data server is firstly determined. In S303, whether or not a number of times the network server program has been executed complies with a predetermined value of the program if the present mode is in monitoring mode is determined. If a result in S303 is true then a monitoring operation is processed in S305, wherein the monitoring operation comprises reading out time information from the time control unit 20, starting to collect the data received by the input unit 40, detecting statuses of the storage unit 60, updating content displayed by the display unit 70, and finally clearing the execution times of the network server program. Alternatively, if the result in S303 is false or after S305, then whether time differences are between unlocking monitoring modes is determined to achieve a predetermined interval time, which is set by the program in S307. If a result in S307 is true, available addresses that correspond to time information provided by the time control unit are calculated and provided. The data is then stored in available addresses in S309. But if the determining result in S307 is false or followed by S309, then the present time information provided by the control unit 20 is determined to comply with a predetermined time point which is set by the program. If a result in S307 is true and is followed by S309, the storing data is integrated and analyzed before the time point for outputting an analysis evaluation report in S313. After S313, if the result in S311 is false, the network server program starts being executed in S315. It is then further determined whether or not a remote inquiring instruction has been received in S317. If a result in S317 is true, then the data which corresponds to the available addresses in the storage unit 60 is read out according to a time point which is provided by the inquiring instruction in S319. After S3139, or if the determining result in S317 is false, the process returns to S301 and continues.

If the present mode which exists in the distributed data server is a time adjusting mode, time information provided by the time control unit 20 is read in S321, and then adjusted in S323. Finally, the time is updated in the time control unit 20 and displayed by the display unit 70 in S325.

If the present mode which exists in the distributed data server is a reporting mode, data allocations are calculated in the storage unit 60, which corresponded to a present time information provided by the time control unit 20 in S327, then an analysis evaluation report in the storage unit 60 is read according to the data allocations. Data displayed on the display unit 70 is then updated in S329.

As above-mentioned, the distributed data server of the present invention may select a monitoring mode, a time adjusting mode, and a reporting mode via a switching device 104. Users may operate the distributed data server directly, and may also access data in the distributed data server from a remote side via the Internet.

The distributed data server of the present invention only uses a micro-control unit 10 incorporated with a network unit 30 to directly connect to the system providing the Internet. Relative to the prior art data server, there are a number of advantages, such as a smaller size, lower cost, greater flexibility, easier construction and higher security, to meet a core system requirement for numbers of portable system researches.

Obviously many modifications and variations are possible in light of the above teachings. It is therefore to be understood that within the scope of the appended claims the present invention can be practiced other than as specifically described herein. Although specific embodiments have been illustrated and described herein, it is obvious to those who are skilled in the art that many modifications of the present invention may be made without departing from what is intended to be limited solely by the appended claims.

What is claimed is:

1. A distributed data server comprises:
a control unit configured to be an embedded system;
a time control unit configured to provide time information required by the control unit;
an input unit configured to be a data input interface which is coupled to the control unit;
at least one storage unit configured for recording data processed by the control unit and for answering remote queries;
a display unit configured for displaying information provided by the control unit; and
a network unit configured to be coupled to the control unit for communicating over the Internet;
wherein the control unit is further configured for determining an abnormal situation of data recorded by the storage unit and further outputting an abnormal signal to show that abnormal situation by being incorporated with the network unit.

2. The distibuted data server according to claim 1, wherein the control unit further comprises:
a microcontroller configured to perform a single chip controller;
an electrically erasable and programmable ROM (EEPROM) configured for storing a firmware program, providing a monitoring mode and a time adjusting mode, reporting said modes for further executing, and incorporation with the microcontroller for operating; and
a switching device configured to be coupled to the microcontroller for selecting a executing mode for the firmware program.

3. The distributed data server according to claim 2, wherein the firmware program is a data server program.

4. The distributed data server according to claim 3, wherein the data server program includes a network server program.

5. The distributed data server according to claim 2, wherein the control unit further comprises: a program recording unit configured to record a firmware program to the EEPROM.

6. The distributed data server according to claim 5, wherein the firmware program is a data server program.

7. The distributed data server according to claim 1, wherein the storage unit is one of a MultiMedia Card/RSMMC/MM, a SecureDigital Card/MiniSD/MicroSD, a Memory Stick/Memory Stick PRO/Memory Stick Duo/Memory Stick PRO Duo, a Type I/II Compact Flash Card, a MicroDrive, a SmartMedia Card/xD, a NAND Flash Memory or a Hard Disk Drive.

8. The distributed data server according to claim 1, wherein the display unit is a kind of Super Twisted Nematic (STN), a Color Super Twisted Nematic (CSTN), a Thin Film Transistor (TFT), a Thin Film Diode (TFD) or an Organic Light Emitting Diode (OLED).

9. The distributed data server according to claim 1, wherein the network unit is a wired or wireless network card.

10. The distributed data server according to claim 1, wherein the abnormal signal is an I/O signal.

11. The distributed data server according to claim 1, further comprising: a power supply unit configured for providing power required by the control unit, the time control unit, the display unit, and the storage unit when operating.

12. The distributed data server according to claim 11, wherein the power supply unit further comprises:
a first power unit configured for providing power required by the control unit, the time control unit, and the storage unit when operating;
a second power unit configured to be an independent power source for the display unit; and
a third power unit configured for providing power required by the time control unit to keep the time control unit operating normally after the first power unit has been shut down.

13. The distributed data server according to claim 12, wherein the third power unit is a kind of carbon battery, alkaline battery, Li battery, pen battery, Nickel-Cadmium battery, Nickel-Metal Hydride battery and Li-ion battery.

14. An operating method for a distributed data server comprising:
receiving outside data via an input unit;
processing the data via a control unit;
storing the processed data in a plurality of available addresses of a storage unit, wherein the available addresses correspond to time information provided by a time control unit; and
determining whether the data is abnormal via the control unit, and outputting an abnormal signal if a determining result is true.

15. The operating method according to claim 14, further comprising transferring the outside data via the input unit to the control unit via a wired or wireless method.

16. The operating method according to claim 14, wherein the control unit comprises a data server program.

17. The operating method according to claim 16, wherein the data server program includes a network server program.

18. The operating method according to claim 14, wherein the outside data is received according to executive times of a network server which are set by the data server.

19. The operating method according to claim 14, wherein the processed data is stored according to time differences between unlocking monitoring modes, which are set by the data server.

20. The operating method according to claim 14, wherein the processed data is stored according to time points which are set by the data server.

21. The operating method according to claim 14, wherein the abnormal situation is a situation in which an environment temperature is higher than a predetermined temperature.

22. The operating method according to claim 14, wherein the abnormal situation is a situation in which no changeable activation in the monitoring data has occurred for a long term.

23. The operating method according to claim 14, wherein the abnormal signal is an I/O signal.

24. The operating method according to claim 14, further comprising logging in to the distributed data server via a network unit for inquiring about relative data in the storage unit.
